(19) United States
(12) Patent Application Publication
(10) Pub. No.: US 2026/0160347 A1
(43) Pub. Date: Jun. 11, 2026

(54) CHECK VALVE

(71) Applicants: Hyundai Motor Company, Seoul (KR); Kia Corporation, Seoul (KR)

(72) Inventor: Jae Jun LEE, Hwaseong-Si (KR)

(21) Appl. No.: 19/223,326

(22) Filed: May 30, 2025

(30) Foreign Application Priority Data
Dec. 11, 2024 (KR) 10-2024-0184236

(51) Int. Cl. F16K 15/02; H01M 8/04082

(52) U.S. Cl. CPC F16K 15/025; H01M 8/04201; H01M 2250/20

(57) ABSTRACT

The present disclosure relates to a check valve including a valve body, a valve poppet, and a gasket. The valve body may include an inlet and an outlet. A valve seat may be disposed at the inlet of the valve body. A fuel passage may connect the inlet to the outlet and be formed inside the valve body. The valve poppet may be disposed in the valve body and configured to open the inlet by moving inside the valve body. The valve poppet may include a flange that extends outward from a bottom portion of the valve poppet. The flange may have a groove on a bottom surface thereof. The gasket may be disposed on an inner surface of the valve body and around the outlet. The gasket may be configured to maintain airtightness while in contact with the valve poppet.

### CROSS-REFERENCE TO RELATED APPLICATION

This application claims priority to Korean Patent Application No. 10-2024-0184236, filed in the Korean Intellectual Property Office on Dec. 11, 2024, the entire contents of which are incorporated herein by reference.

### TECHNICAL FIELD

The present disclosure relates to a check valve.

### BACKGROUND

A fuel cell electric vehicle (FCEV) generates electric energy through an electrochemical reaction between oxygen and hydrogen in a fuel cell stack and uses the generated electric energy as a power source.

The FCEV's ability to replenish fuel and air from the outside, regardless of a capacity of a battery cell, and its high efficiency and low emission factors make the FCEV a very attractive candidate for continual research and development.

The FCEV may be provided with a plurality of hydrogen tanks. Hydrogen may be supplied through a hydrogen fuel line (e.g., a hose) of a hydrogen storage system and stored in the hydrogen tanks. The hydrogen stored in the hydrogen tank may be decompressed through a regulator along the hydrogen supply line and then supplied to the fuel cell stack to generate electrical energy.

Further, the FCEV may be provided with a hydrogen filling receptacle that can connect to a nozzle of a fuel dispenser through which a hydrogen gas is supplied. The hydrogen supplied through the receptacle may travel through a manifold before being stored in the hydrogen tank. In addition, the receptacle may be provided with a check valve for preventing reverse flow of the hydrogen.

The check valve should be kept airtight within a certain pressure range (e.g., approximately 5 bar to 900 bar) of the fuel system in the vehicle. The airtightness may be determined by a surface pressure between a valve seat and a valve poppet, and this surface pressure may be affected by a force, for moving the valve poppet, as exerted by an internal/external pressure difference (e.g., a tensile strength of an elastic body or elastic material). Thus, maintaining airtightness at low pressure (e.g., about 5 bar) can be a relatively difficult task as compared to high pressure, and to overcome this, an elastic material having a strong tensile strength may be applied (e.g., if tolerance management is more difficult, increasing the tensile strength of the elastic material during the design stage may be needed to ensure the required level of quality).

However, using an elastic material with a tensile strength that is too high may increase the pressure difference between a fueling station and a vehicle during fueling, and thus the amount of filled hydrogen (e.g., hydrogen tank capacity) may be adversely affected.

Further, during fueling, chattering of the valve poppet due to resistance caused by the tensile strength of the elastic material.

The matters described in this Background section are only for enhancement of understanding of the background of the disclosure, and should not be taken as acknowledgment that they correspond to prior art already known to those skilled in the art.

### SUMMARY

The present disclosure has been made to solve the above-mentioned problems occurring in the prior art while advantages achieved by the prior art are maintained intact.

An aspect of the present disclosure provides a check valve capable of preventing occurrence of abnormal operation noise due to a chattering phenomenon of a valve plunger when a hydrogen fuel is filled.

Another aspect of the present disclosure provides a check valve capable of achieving a high amount of filled hydrogen (e.g., a high storage capacity) regardless of a tensile strength of an elastic body.

Still another aspect of the present disclosure provides a check valve capable of preventing reverse flow of a hydrogen fuel as well as leakage of the hydrogen fuel as a valve plunger may achieve a stronger surface pressure and maintain airtightness performance (e.g., a seal).

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a check valve may include a valve body, a valve poppet, and a gasket. The valve body may include an inlet and an outlet. A valve seat may be disposed at the inlet of the valve body. A fuel passage, connecting the inlet to the outlet, may be formed inside the valve body. The valve poppet may be disposed in the valve body and configured to open the inlet by moving inside the valve body. The valve poppet may include a flange that extends outward from a bottom portion of the valve poppet. The bottom portion of the valve poppet may be located closer to the outlet than to the inlet. The flange may have a groove on a bottom surface thereof. The gasket may be disposed on an inner surface of the valve body and around the outlet. The gasket may be configured to maintain airtightness while in contact with the valve poppet.

An inner surface of the groove may be concentric with an outer circumferential surface of the flange. The groove may be recessed from the inner surface of the groove toward a center of the valve poppet.

The flange further may include a contact surface formed between the outer circumferential surface and the inner surface of the groove. The contact surface may be configured to contact the gasket.

The groove may include a tapered groove such that an inner diameter of the groove narrows toward the inlet and widens toward the outlet.

The gasket may include a tapered protrusion having an outer diameter that widens toward the outlet and narrows toward the inlet.

The groove may include a tapered groove. The tapered groove and the tapered protrusion may interlock with each other.

The valve body may have a top surface, a bottom surface, and a first cylindrical wall connecting the top surface and the bottom surface of the valve body. The top surface, the bottom surface of the valve body, and the first cylindrical wall of the valve body may form a valve cavity.

An inlet hole of the inlet may be formed at a center of the top surface. An outlet hole of the outlet may be formed at a center of the bottom surface of the valve body. The inlet hole and the outlet hole may connect to the valve cavity. The top surface may include the valve seat that is disposed around the inlet hole.

The valve may be poppet disposed in the valve cavity of the valve body. The valve poppet may include: a tapered top surface, the flange, and a second cylindrical wall. The flange may be configured to create a first seal between the valve body and the valve poppet. The flange may have an opening into a valve poppet cavity and comprises a circular lip disposed around an outer edge of the flange and protruding toward the outlet hole. The second cylindrical wall may connect the tapered top surface and the flange. The second cylindrical wall may have one or more holes connecting to the valve poppet cavity.

The check may further include a spring disposed inside the valve poppet cavity and configured to compress or decompress between the valve poppet and the gasket.

The valve poppet may be configured to: slide toward the inlet hole such that the tapered top surface of the valve poppet contacts the valve seat to create a blockage of the inlet hole, or slide toward the outlet hole such that the circular lip of the flange contacts the gasket to create a second seal and the fuel passage is formed.

The fuel passage may connect the inlet hole, the valve cavity, the one or more holes of the second cylindrical wall, the valve poppet cavity, and the outlet hole.

According to one or more example embodiments of the present disclosure, a check valve may include a valve body having a top surface, a bottom surface, and a first cylindrical wall connecting the top surface and the bottom surface. The top surface, the bottom surface, and the first cylindrical wall of the valve body may form a valve cavity. An inlet hole may be formed at a center of the top surface. An outlet hole may be formed at a center of the bottom surface. The inlet hole and the outlet hole may connect to the valve cavity. The top surface may include a valve seat disposed around the inlet hole. The check valve may further include a valve poppet disposed in the valve cavity of the valve body. The valve poppet may include: a tapered top surface; and a flange having an opening into a valve poppet cavity. The flange may be configured to create a first seal between the valve body and the valve poppet. The flange may include a circular lip disposed around an outer edge of the flange and protruding toward the outlet hole. The valve poppet may further include a second cylindrical wall connecting the tapered top surface and the flange. The second cylindrical wall may have one or more holes connecting to the valve poppet cavity. The check valve may further include a gasket disposed around the outlet hole on an inner surface of the bottom surface of the valve body; and a spring disposed inside the valve poppet cavity and configured to compress or decompress between the valve poppet and the gasket. The valve poppet may be configured to: slide toward the inlet hole to be in a first position or slide toward the outlet hole to be in a second position. When the valve poppet is in the first position, the tapered top surface of the valve poppet may contact the valve seat to create a blockage of the inlet hole. When the valve poppet is in the second position, the circular lip of the flange may contact the gasket to create a second seal, and a fuel passage may be formed to connect the inlet hole, the valve cavity, the one or more holes of the second cylindrical wall, the valve poppet cavity, and the outlet hole.

The spring may be configured to: decompress when the valve poppet slides toward the inlet hole; or compress when the valve poppet slides toward the outlet hole.

The circular lip may include a tapered wall with an inner diameter that narrows toward the inlet hole and widens toward the outlet hole.

The gasket may include a tapered edge with an outer diameter that narrows toward the inlet hole and widens toward the outlet hole.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a hydrogen fueling system;

FIG. 2 is a schematic cross-sectional view illustrating a check valve;

FIG. 3 is a view illustrating an open state of the check valve in an environment in which a hydrogen fuel is filled; and

FIG. 4 is a schematic cross-sectional view illustrating a check valve.

### DETAILED DESCRIPTION

Hereinafter, one or more example embodiments of the present disclosure will be described in detail with reference to the exemplary drawings. It should be noted that, when the reference numerals are added to the components of the drawings, the same components have the same reference numerals even when the components are illustrated in different drawings. Further, in describing the example embodiment of the present disclosure, a detailed description of the related known configuration or function will be omitted when it is determined that it interferes with the understanding of the example embodiment of the present disclosure.

Further, in the description of components of the example embodiments of the present disclosure, the terms such as first, second, A, B, (a) and (b) may be used. These terms are merely intended to distinguish one component from other components, and the terms do not limit the nature, order, or sequence of the components. It should be understood that when one component is “connected”, “coupled” or “joined” to another component, the former may be directly connected or jointed to the latter or may be “connected”, “coupled” or “joined” to the latter with a third component interposed therebetween.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, before a check valve 100 is described in detail with reference to the accompanying drawings, a hydrogen fueling system in which the check valve 100 is installed will be briefly described.

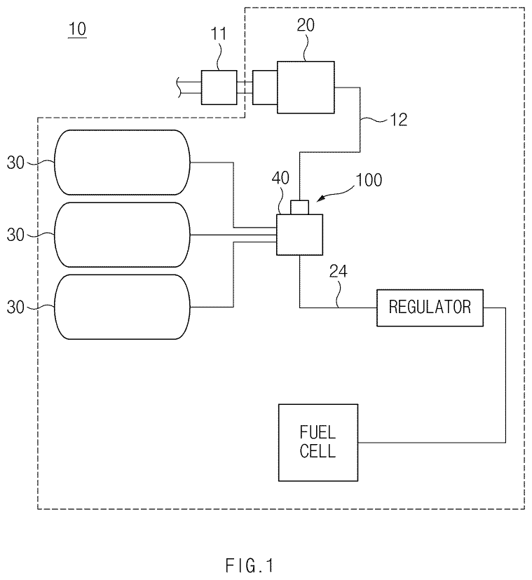

FIG. 1 is a view illustrating a hydrogen fueling system.

Referring to FIG. 1, a hydrogen fueling system (also referred to as a hydrogen filling system) 10 may include a receptacle 20, which is provided in a fuel cell electric vehicle (FCEV) and to which a fueling nozzle (also referred to as a filling nozzle) 11 that supplies hydrogen may be connected. The hydrogen fueling system 10 may further include a manifold 40 connected to one or more hydrogen tanks 30 provided in the FCEV, a hydrogen fuel line (also referred to as a hydrogen filling line) 12 connecting the receptacle 20 to the manifold 40, and the check valve 100 that is provided between the receptacle 20 and the manifold 40. The check valve 100 may control supply of the hydrogen supplied to the manifold 40 through the hydrogen fuel line 12.

The hydrogen fueling system 10 may be applied to conventional passenger vehicles or commercial vehicles, and the present disclosure is not restricted or limited by the type and structure of the vehicles to which the hydrogen fueling system 10 is applied.

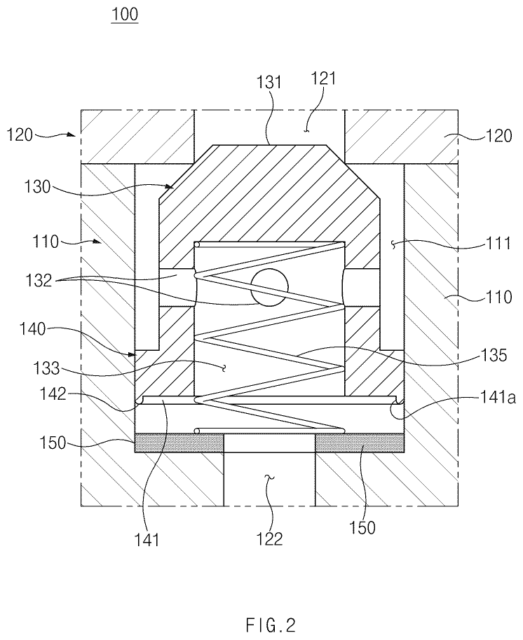

FIG. 2 is a schematic cross-sectional view illustrating the check valve 100.

In FIG. 2, the check valve 100 may be connected to the hydrogen fuel line 12 between the receptacle 20 and the manifold 40 of FIG. 1.

The check valve 100 may be formed in various structures capable of preventing reverse flow of a hydrogen fuel (e.g., restrict the flow of the hydrogen fuel to one direction only) and/or controlling the amount of the hydrogen fuel supplied to the one or more hydrogen tanks 30.

The check valve 100 may include a valve seat 120 installed on an inlet side thereof. The check valve 100 may include a valve body 110 having a circular cross-section. The valve body 110 may have a substantially cylindrical shape. The valve seat 120 may have a circular (e.g., ring) shape and affixed to the top portion of the valve body 110, thereby creating a seal between the valve seat 120 and the valve body 110.

The check valve 100 (e.g., valve body 110) may have an inflow passage 121 and a discharge passage 122, through which the hydrogen fuel may pass, on an inlet side and an outlet side, respectively.

The valve body 110 may include a fuel passage 111, which connects to an inlet, an outlet, and the hydrogen fuel line 12.

The valve body 110 may include a valve poppet 130, which is provided to be movable inside the valve body 110 and selectively opens or closes the fuel passage 111. The valve poppet may have a substantially cylindrical shape. An elastic body mounting chamber (also referred to as an elastic body mounting space, a valve poppet cavity, an elastic body housing, or an elastic body enclosure) 133 may be formed, for example, on an inner surface of the valve poppet 130. An elastic body (also referred to as an elastic material) 135 may be inserted into the elastic body housing 133. The elastic body may be a spring. The elastic body may support the valve poppet 130. For example, the elastic body may, when compressed, exert a force to the valve poppet 130 and return the valve poppet 130 to its closed position (e.g., the valve poppet 130 making contact with the valve seat 120 to create a seal or a blockage between the valve seat 120 and the valve poppet 130).

The elastic body mounting chamber 133 may be a space (e.g., a cavity, a chamber, a pocket, etc.) in which the elastic body 135 may exert an elastic force while compressed or stretched. The elastic body mounting chamber 133 and the fuel passage 111 may be arranged to connect (e.g., vent) to each other.

The valve poppet 130 may include a protrusion 131 protruding from a center of the valve body 110 toward an inlet of the valve body 110 to maintain airtightness (e.g., a seal) as a tip thereof is pressed against the inflow passage 121 of the valve seat 120. The protrusion 131 may taper off (e.g., at an angle) from the cylindrical body of the valve poppet 130 in a conic or partially conic shape. During the fueling of hydrogen, the pressure of the hydrogen fuel being introduced into the inlet of the valve body 110 may move the valve poppet 130 (e.g., push the valve poppet 130 further down into the valve body 110) to create a passage for the hydrogen fuel. After the hydrogen fueling is complete, the surface pressure between the valve seat 120 and the valve poppet 130 may be formed to maintain the seal (e.g., hermetic seal).

One or more passage holes 132 may be formed on the valve poppet 130 (e.g., on the walls of the valve poppet 130) such that the hydrogen fuel entering through the inflow passage 121 of the valve seat 120 from the inlet side and flowing through the fuel passage 111 inside the valve body 110 may be discharged to the outlet through the elastic body mounting chamber 133. The passage hole(s) 132 may be formed as a plurality of passage holes 132 that connect the fuel passage 111 to the elastic body mounting chamber 133 and are formed through an outer circumferential surface (e.g., wall) of the valve poppet 130.

The valve poppet 130 may include a flange (e.g., a rib, a collar, a rim, etc.) 140 that blocks the fuel passage 111 and prevents the hydrogen fuel introduced into the fuel passage 111 from flowing toward the outlet (e.g., disposed on an opposite side from the protrusion 131) of the valve body 110. Thus, the flange 140 may cause the hydrogen fuel to flow toward the outlet only through the passage hole(s) 132. The flange 140 may be disposed on a bottom portion of the valve poppet 130 (e.g., at the bottom edge). The bottom portion of the valve poppet 130 may be closer to the outlet than it is to the inlet.

The flange 140 may have a circular plate shape formed at one end (e.g., a bottom end) of the valve poppet 130 and extending outward. The flange 140 may be supported on an outlet side of the valve body 110.

A gasket (also referred to as an airtightness maintaining part) 150 may be provided on the outlet side of the valve body 110 corresponding to the flange 140 of the valve poppet 130. The gasket 150 may be made of an elastic material (e.g., a deformable material) capable of maintaining the airtightness (e.g., seal) of the valve poppet 130 when the flange 140 of the valve poppet 130 comes into contact with (e.g., contacts) the gasket 150.

The gasket 150 may be made out of any of the various materials that are capable of achieving an excellent seal (e.g., hermetic seal) when the gasket 150 comes into contact with (e.g., contacts) the flange 140.

The flange 140 may include a groove (also referred to as a groove portion, a depression, or a depressed surface) 141 and a contact surface (also referred to as a contact surface portion or a lip) 142 on a rear surface (e.g., bottom surface) thereof. The rear (bottom) surface of the valve poppet 130 (e.g., flange 140) may be directed toward the outlet.

The flange 140 may have an inner surface concentric with an outer circumferential surface thereof. The flange 140 may include the groove 141 that is recessed from the inner surface toward a center thereof. The groove 141 may be a planar groove in which the entire groove (e.g., depression) has the same depth. The groove 141 may connect to the elastic body mounting chamber 133 and the discharge passage 122.

Further, the flange 140 may include the contact surface 142 that is formed between the outer circumferential surface and the inner surface of the flange 140 and excluding the groove 141. The contact surface 142 may be in contact with the gasket 150. The contact surface 142 may be a ring-shaped lip that lines the circumferential edges of the bottom surface of the valve poppet 130 (e.g., the flange 140).

The groove 141 may be formed as an area A2 to which a pressure P2 of the hydrogen fuel introduced through the outlet is applied. The contact surface 142 may be excluded from the entire area of the flange 140, and thus the groove 141 may be formed relatively smaller than the entire surface of the flange 140.

FIG. 2 illustrates a state (e.g., a closed state or closed position) in which the check valve 100 blocks the inflow passage of the valve seat 120. That is, the valve seat 120 and the valve poppet 130 may be in contact with each other to create a blockage and maintain the airtightness (e.g., seal). A state (e.g., position) of the check valve 100 as shown in FIG. 2 may be the default state (e.g., default position) that is maintained except during hydrogen fueling. The pressure (e.g., surface pressure) may be formed between the valve seat 120 and the valve poppet 130 by a pressure of the hydrogen tank(s) 30 and a load of the elastic body 135, so that the airtightness (e.g., seal) may be maintained.

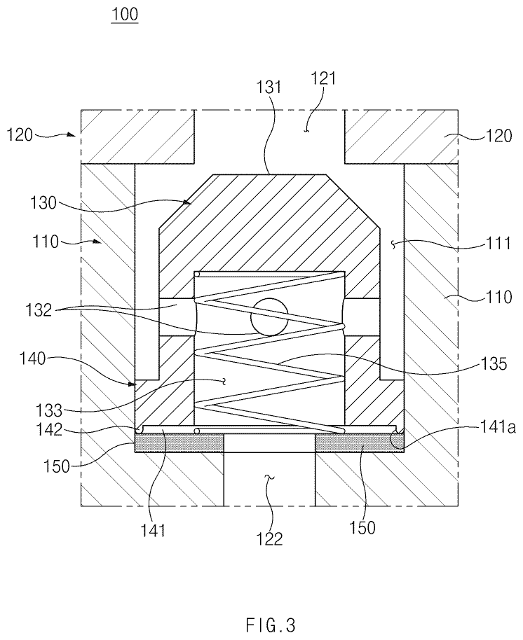

FIG. 3 is a view illustrating an open state (e.g., open position) of the check valve 100 during hydrogen fueling.

Referring to FIG. 3, when the fueling starts, a fueling pressure (also referred to as a filling pressure) P1 of the valve body 110 on the inlet side may increase to become greater than the pressure of the hydrogen tank(s) 30 and the load of the elastic body 135, and the valve poppet 130 may be lowered (e.g., pushed down) due to a pressure difference between the inlet side and the outlet side to create a passage.

In the closed state as shown in FIG. 2, the airtightness (e.g., seal) between the valve seat 120 and the valve poppet 130 may be maintained while the valve poppet 130 creates a blockage at the valve seat 120. If the valve poppet 130 is lowered due to a pressure difference between the inlet side and the outlet side of the valve body 110 to create the passage, the fueling pressure P1 of the hydrogen fuel (e.g., supplied from a fueling station) may be applied to the valve poppet 130, and the valve poppet 130 may separate from the valve seat 120 and move toward the outlet. The valve poppet 130 may move toward and/or come into contact with the gasket 150.

When the valve poppet 130 comes into contact with (e.g., contacts) the gasket 150, the contact surface 142 of the flange 140 (e.g., not including the groove 141) may come into contact with (e.g., contact) an outer portion of the gasket 150, and the groove 141 may be positioned at a predetermined distance away from the gasket 150. Thus, in this position, the groove 141 may not be in contact with the gasket 150.

Thus, the pressure P2 of the hydrogen fuel introduced through the outlet of the valve body 110 of the hydrogen tank 30 may be applied to the area A2 of the groove 141 except for the contact surface 142 of the flange 140.

FIG. 3 illustrates a state in which the hydrogen fuel is filled (e.g., a state in which the hydrogen fuel enters the check valve 100 and the valve poppet 130 comes into contact with (e.g., contacts) the gasket 150 to open the passage).

As the FCEV requires a higher fueling flow rate of the hydrogen fuel, a size of the passage hole 132 formed in the valve poppet 130 may become large to create an area of the passage, but in this case, a differential pressure between the fueling pressure P1 and the pressure P2 of the hydrogen tank 30 may be relatively small, and thus a pressure of pressing the valve poppet 130 is reduced. Accordingly, the valve poppet 130 may not be supported by the gasket 150 on the outlet side of the valve body 110, and chattering or vibration (e.g., of the valve poppet 130) may occur.

After the hydrogen fueling is complete, the differential pressure between the fueling pressure P1 and the pressure P2 of the hydrogen tank 30 may increase in proportion to the load of the elastic body 135. That is, the fueling pressure P1 may decrease, the pressure P2 of the hydrogen tank 30 may be maintained in an original state thereof, and thus, the differential pressure may increase.

Thus, in order to improve a passage opening pressure of the check valve 100 after the hydrogen fuel is completely filled, an elastic force of the spring may be weakened (e.g., a spring having a lower elastic force may be used), but it may be more difficult to maintain the airtightness (e.g., seal) in a state in which the check valve 100 is blocked.

Thus, even when the elastic force of the elastic body 135 is set to be large (e.g., a spring having a higher elastic force is used), the fueling pressure P1 of the valve body 110 on the inlet side may be applied to an area A1 of the valve poppet 130. Further, the pressure P2 of the hydrogen tank 30 may be applied to the groove 141 of the flange 140 of the valve poppet 130. Thus, since a load F1 of the valve body 110 on the inlet side is greater than a load F2 of the hydrogen tank 30, it is designed that the pressures and the applied areas of the valve body 110 on the inlet side and the outlet side are different, and thus chattering of the valve poppet 130 may be reduced or prevented in a state in which the valve poppet 130 is fixed to the gasket 150. Further, fueling may be performed in a state in which a difference between the fueling pressure P1 of the valve body 110 on the inlet side and the pressure P2 of the hydrogen tank 30 is lowered regardless of the load of the elastic body 135.

Hereinafter, in describing the check valve 100, the same reference numerals are used for components having the same configuration and the same function, and detailed descriptions of these components will be omitted to avoid repetitive configurations.

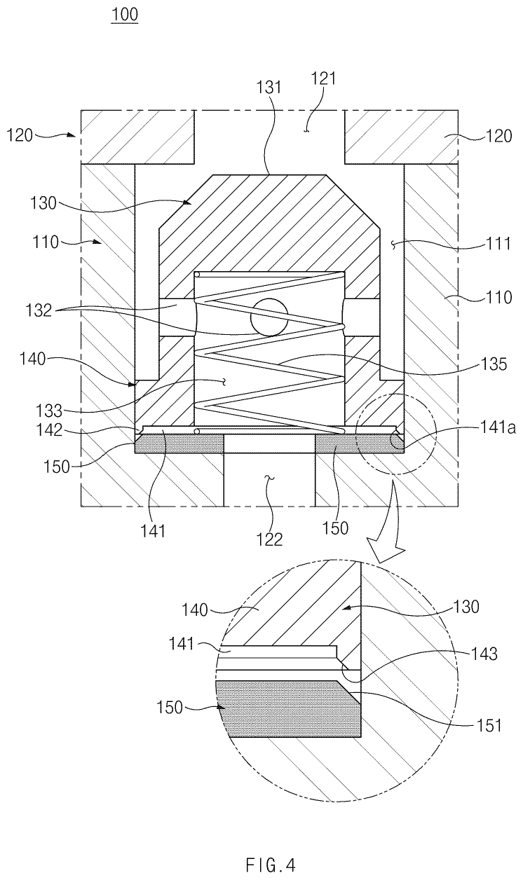

FIG. 4 is a schematic cross-sectional view illustrating the check valve 100.

As illustrated in FIG. 4, the valve poppet 130 may include the flange 140 that blocks the fuel passage 111 when the hydrogen fuel is introduced toward the outlet of the valve body 110 on an opposite side to the protrusion 131. The flange 140 may include the groove 141 and the contact surface 142 on the rear surface thereof.

The flange 140 has the inner surface concentric with the outer circumferential surface thereof and includes the groove 141 recessed from the inner surface toward the center thereof. The groove 141 may have the planar groove in which the entire groove has the same depth.

A tapered (or inclined) groove 143 having a tapered shape in which an open outlet side of the valve body 110 is wide and of which an inner diameter becomes narrower toward the inlet of the valve body 110 may be formed on one side of the groove 141. In other words, the groove may include a tapered wall such that an inner diameter of the groove narrows toward the inlet and widens toward the outlet. The tapered (or inclined) groove 143 may be formed to face a corresponding surface of the gasket 150.

The gasket 150 corresponding to the tapered groove 143 may include a tapered (or inclined) protrusion 151 having a tapered shape of which an outer diameter is widened from a corresponding surface corresponding to the tapered groove 143 toward the outlet of the valve body 110.

The corresponding surfaces of the tapered groove 143 and the gasket 150 may be fixed in surface contact with each other. In other words, the corresponding surfaces of the tapered groove 143 and the gasket 150 may interlock with each other.

That is, when the valve poppet 130 moves toward the outlet of the valve body 110 and is inserted into the tapered groove 143 of the flange 140 in the tapered protrusion 151 of the gasket 150, the valve poppet 130 may be fixed to the gasket 150.

In this state, the load F1 of the valve body 110 on the inlet side and the load F2 of the hydrogen tank 30 may be applied in the same manner as described above, and the effects as well as the applications may be derived in the same manner.

According to an aspect of the present disclosure, a check valve includes a valve body having a valve seat installed therein and including a fuel passage between an inlet and an outlet, a valve poppet that selectively opens or closes the valve seat while moving inside the valve body, extends outward from the outlet, and includes a flange part having a groove portion on a rear surface thereof, and an airtightness maintaining part that is installed on the outlet of the valve body and maintains airtightness while in contact with the valve poppet.

The groove portion may have an inner surface concentric with an outer circumferential surface of the flange part and may be recessed from the inner surface toward a center.

The flange part may further include a contact surface portion formed between the outer circumferential surface and the inner surface and in contact with the airtightness maintaining part.

A tapered groove portion having a tapered shape in which the open outlet of the valve body is wide and of which an inner diameter becomes narrower toward the inlet of the valve body may be formed on one side of the groove portion.

The airtightness maintaining part may include a tapered protrusion having a tapered shape of which an outer diameter is widened from a corresponding surface corresponding to the tapered groove portion toward the outlet of the valve body.

Corresponding surfaces corresponding to the tapered groove portion and the airtightness maintaining part may be fixed in surface contact with each other.

According to the check valve according to the present disclosure as described above, when a hydrogen fuel is filled, occurrence of abnormal operation noise due to a chattering phenomenon of a valve poppet may be prevented.

According to the present disclosure, a high amount of filled hydrogen (e.g., a high storage capacity) may be achieved regardless of a tensile strength of an elastic body.

According to the present disclosure, reverse flow of a hydrogen fuel as well as leakage of the hydrogen fuel may be prevented with a valve plunger achieving a stronger surface pressure and maintaining a seal.

The above description of the present disclosure is for illustration, and those skilled in the art to which the present disclosure pertains may understand that the present disclosure may be easily modified into other specific forms without changing the technical spirit or essential feature of the present disclosure. Therefore, it should be understood that the example embodiments described above are illustrative but not limiting in all aspects. The scope of the present disclosure is indicated by the appended claims, and all changes or modifications derived from the meaning and scope of the appended claims and equivalent concepts thereof should be construed as being included in the scope of the present disclosure.

What is claimed is:

1. A check valve comprising:
a valve body comprising an inlet and an outlet, wherein a valve seat is disposed at the inlet of the valve body, and wherein a fuel passage, connecting the inlet to the outlet, is formed inside the valve body;
a valve poppet disposed in the valve body and configured to open the inlet by moving inside the valve body, wherein the valve poppet comprises a flange that extends outward from a bottom portion of the valve poppet, the bottom portion of the valve poppet being located closer to the outlet than to the inlet, and wherein the flange has a groove on a bottom surface thereof; and
a gasket disposed on an inner surface of the valve body and around the outlet, wherein the gasket is configured to maintain airtightness while in contact with the valve poppet.

2. The check valve of claim 1, wherein an inner surface of the groove is concentric with an outer circumferential surface of the flange, and wherein the groove is recessed from the inner surface of the groove toward a center of the valve poppet.

3. The check valve of claim 2, wherein the flange further comprises a contact surface formed between the outer circumferential surface and the inner surface of the groove, and wherein the contact surface is configured to contact the gasket.

4. The check valve of claim 1, wherein the groove comprises a tapered groove such that an inner diameter of the groove narrows toward the inlet and widens toward the outlet.

5. The check valve of claim 1, wherein the gasket comprises a tapered protrusion having an outer diameter that widens toward the outlet and narrows toward the inlet.

6. The check valve of claim 5, wherein the groove comprises a tapered groove, and wherein the tapered groove and the tapered protrusion interlock with each other.

7. The check valve of claim 1, wherein the valve body has a top surface, a bottom surface, and a first cylindrical wall connecting the top surface and the bottom surface of the valve body, and wherein the top surface, the bottom surface of the valve body, and the first cylindrical wall of the valve body form a valve cavity.

8. The check valve of claim 7, wherein an inlet hole of the inlet is formed at a center of the top surface, wherein an outlet hole of the outlet is formed at a center of the bottom surface of the valve body, wherein the inlet hole and the outlet hole connect to the valve cavity, and wherein the top surface comprises the valve seat that is disposed around the inlet hole.

9. The check valve of claim 8, wherein the valve is poppet disposed in the valve cavity of the valve body, wherein the valve poppet comprises:
a tapered top surface,
the flange, wherein the flange, configured to create a first seal between the valve body and the valve poppet, has an opening into a valve poppet cavity and comprises a circular lip disposed around an outer edge of the flange and protruding toward the outlet hole, and
a second cylindrical wall connecting the tapered top surface and the flange, wherein the second cylindrical wall has one or more holes connecting to the valve poppet cavity.

10. The check valve of claim 9, further comprising a spring disposed inside the valve poppet cavity and configured to compress or decompress between the valve poppet and the gasket.

11. The check valve of claim 9, wherein the valve poppet is configured to:
slide toward the inlet hole such that the tapered top surface of the valve poppet contacts the valve seat to create a blockage of the inlet hole, or
slide toward the outlet hole such that the circular lip of the flange contacts the gasket to create a second seal and the fuel passage is formed.

12. The check valve of claim 11, wherein the fuel passage connects the inlet hole, the valve cavity, the one or more holes of the second cylindrical wall, the valve poppet cavity, and the outlet hole.

13. A check valve comprising:
a valve body having a top surface, a bottom surface, and a first cylindrical wall connecting the top surface and the bottom surface, wherein the top surface, the bottom surface, and the first cylindrical wall of the valve body form a valve cavity, wherein an inlet hole is formed at a center of the top surface, wherein an outlet hole is formed at a center of the bottom surface, wherein the inlet hole and the outlet hole connects to the valve cavity, and wherein the top surface comprises a valve seat disposed around the inlet hole;
a valve poppet disposed in the valve cavity of the valve body, wherein the valve poppet comprises:
a tapered top surface;
a flange having an opening into a valve poppet cavity, wherein the flange is configured to create a first seal between the valve body and the valve poppet, and wherein the flange comprises a circular lip disposed around an outer edge of the flange and protruding toward the outlet hole; and
a second cylindrical wall connecting the tapered top surface and the flange, wherein the second cylindrical wall has one or more holes connecting to the valve poppet cavity;
a gasket disposed around the outlet hole on an inner surface of the bottom surface of the valve body; and
a spring disposed inside the valve poppet cavity and configured to compress or decompress between the valve poppet and the gasket,
wherein the valve poppet is configured to slide toward the inlet hole to be in a first position or slide toward the outlet hole to be in a second position,
wherein, when the valve poppet is in the first position, the tapered top surface of the valve poppet contacts the valve seat to create a blockage of the inlet hole, and
wherein, when the valve poppet is in the second position, the circular lip of the flange contacts the gasket to create a second seal, and a fuel passage is formed to connect the inlet hole, the valve cavity, the one or more holes of the second cylindrical wall, the valve poppet cavity, and the outlet hole.

14. The check valve of claim 13, wherein the spring is configured to:
decompress when the valve poppet slides toward the inlet hole; or
compress when the valve poppet slides toward the outlet hole.

15. The check valve of claim 13, wherein the circular lip comprises a tapered wall with an inner diameter that narrows toward the inlet hole and widens toward the outlet hole.

16. The check valve of claim 13, wherein the gasket comprises a tapered edge with an outer diameter that narrows toward the inlet hole and widens toward the outlet hole.
